(19) United States
(12) Patent Application Publication
(10) Pub. No.: US 2008/0281746 A1
(43) Pub. Date: Nov. 13, 2008

(54) Computer-based method of commodity trading automation

(76) Inventor: Sergey Yuryevich Abrashin, Norwalk, CT (US)

Correspondence Address: Sergey Yuryevich Abrashin, 21 Newfield St., Norwalk, CT, 06850, US

(21) Appl. No.: 11/746,058

(22) Filed: May 8, 2007

(51) Int. Cl. G06Q 40/00

(52) U.S. Cl. 705/37

(57) ABSTRACT

The present invention introduces a method which may be implemented on a variety of computer systems. The method of the present invention can be used for commodity trading automation and provides the core components to build an actual system and use it for position and risk management, valuation, settlement, scheduling and other commodity trading processes.

### CROSS REFERENCE TO RELATED APPLICATIONS

This application claims priority to U.S. provisional patent application Ser. No. 60/746,774, filed May 8, 2006.

### BACKGROUND OF THE INVENTION

Traditional commodity trading systems do not provide the traders and business analysts the sufficient ability to design the processing procedures. Distinctions in business practice for different markets, companies and commodities lead to mandatory customization for present trading systems and result in complexity, high cost, low performance and delays in system implementations.

### SUMMARY OF THE INVENTION

The basis of computer-based method of commodity trading automation is the combination of regular relational model, mathematical equations, and vector algebra. It also comprises the processing decomposition to the elementary steps and an implementation of the commodity trading basis elements: a schedule object and a schedule generator, a discrete function data with ability to transpose it to other schedules.

### BRIEF DESCRIPTION OF THE SEVERAL VIEWS OF THE DRAWING

FIG. 1 is a block diagram with the main components of the present invention

FIG. 2 is an example of the unit of measure editor with the unit of measure definitions

FIG. 3 is an example of the business object definition editor with the trade attribute definitions.

FIG. 4 is an example of the business object editor with mathematical function viewer

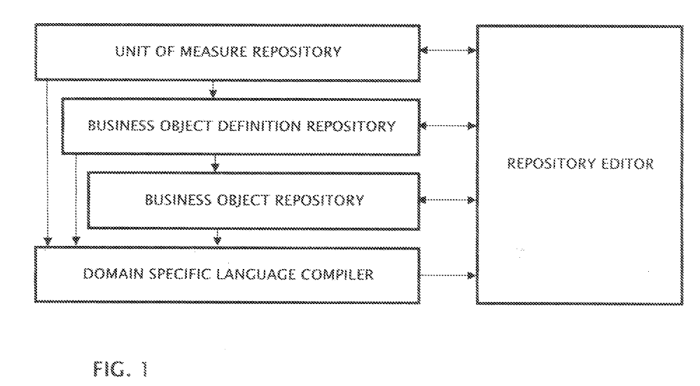

### DETAILED DESCRIPTION

Plurality of commodity trading tasks requires the analysis of the functional dependences. The mathematical concept of a function expresses the dependence between two quantities and the describing method comprises two representations of a mathematical function: mathematical expression (referred to herein as expression) and a map of input and output values (referred to herein as function data). Commodity trading tasks also require specifying the unit of measure (referred to herein as UOM) for the quantities. A transformation process from expression to function data is the calculation process.

The calculation process starts from the variables and its UOMs resolving. This process should simplify whenever it is possible the UOMs after the binary multiplicative operations. The variables joined by binary additive operators should be converted to the same UOM. The resolving process adds the conversion factors to the original expression where it is necessary. The resulting prepared expression can be stored into repository.

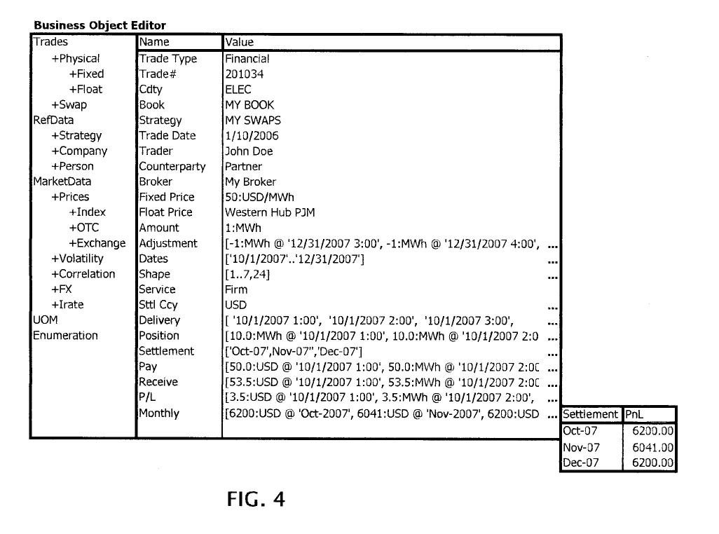

The describing method comprises the abstract UOMs to specify a class of unit of measures. Abstract UOMs can be used only for business object attribute definitions. For instance, referring to FIG. 3, an attribute Fixed from object definition is defined as Currency/Quantity but this attribute from object itself on FIG. 4 is 50:USD/MWh.

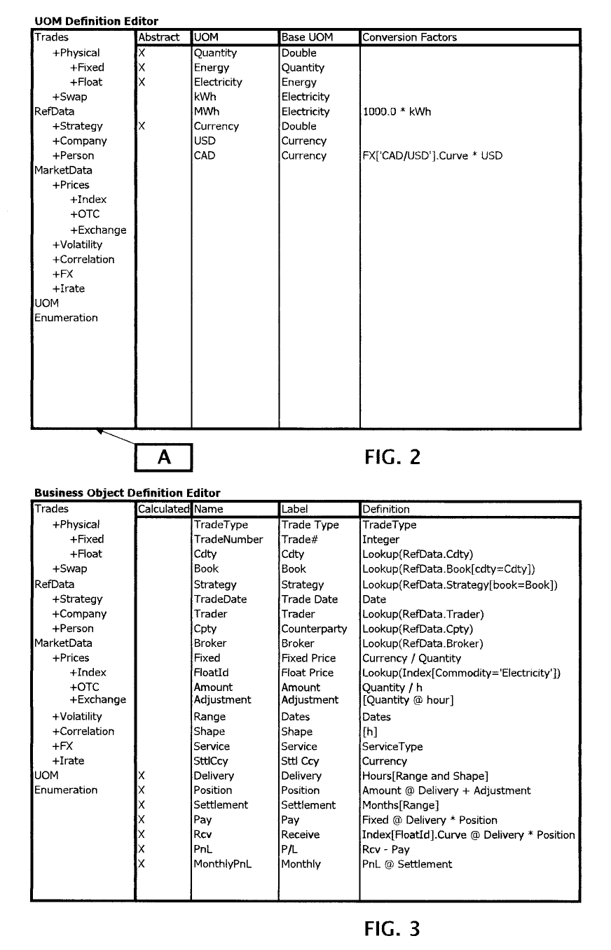

Base type of UOM can be another UOM, primitive type, or collection type. Conversion factors for UOM translations can be defined through mathematical expressions. Referring to FIG. 2 conversion factor from MWh to kWh is defined as floating-point number, and the conversion factor from CAD to USD references to another business object attribute, which is a Foreign Exchange market price function selected by object name—‘CAD/USD’. UOM of business object attribute can be a combination of other UOMs joined by mathematical operators comprising binary multiplicative operators: division, multiplication, and power operator.

Discrete mathematical function of time contains a list of observation time points or time periods. A time point includes at least the following attributes: year, month, week of the month, day, day of the week, hour, minute, second. These attributes can be used by a schedule generator to select a finite set of time points or time periods from an infinite continuous time. The filtering predicates connected by logical operators allow generating the plurality of time schedules. Referring to FIG. 4 the attribute Range defines the range of dates as [‘10/1/2007’ . . . ‘12/31/2007’] and the attribute Shape defines the list of hours as [1 . . . 7, 24]. These filters are used to create a variable Delivery on FIG. 3 as Hours[Range and Shape]. The schedule generator should take a range of dates and a list of hour values and produces the list of hours. The filter values and time object attributes can be matched by specified UOM. Another example illustrates the Off-Peak schedule generation from the list of holiday dates. Off-Peak schedule can be defined as Hours[Range and ([1 . . . 7, 24]:hours or Weekend or Holidays)] where Holidays variable is the list of holidays and Weekend variable is the list of weekdays—[Saturday, Sunday]. Variable Settlement from FIG. 3 shows the monthly schedule generation. It creates the list of settlement months from delivery dates. This notation specifies the time period type and a filter enclosed in square brackets.

Referring to FIG. 3, an operator @ creates a mathematical function from two quantities. Amount @ Delivery expression creates function data from scalar and delivery schedule. Prices[FloatId].Curve @ Delivery transposes the price curve to the delivery schedule. Transposition type depends on UOM of transposed values. The described method comprises two types of transposition: quantity type of transposition and coefficient type of transposition. The quantity type of transposition in the mathematical function of time integrates the values from smaller time periods to bigger time periods and spreads the values from bigger to smaller time periods. The positions and costs in trading are the example of quantity transposition. Coefficient type of transposition in the mathematical function of time averages the values from smaller to bigger time periods and transfers the values from bigger to smaller time periods. Price[FloatId].Curve @ Delivery is the example of a coefficient type of transposition.

If a user marked an attribute as calculated, the business object editor should not allow the editing of this read-only attribute. In that case the domain specific language (referred to herein as DSL) compiler or translator calculates the actual values from the expression by request. The expression can contain the references to attributes of the same object or attributes from other business objects.

The describing method comprises arithmetic operations with mathematical functions. Referring to FIG. 3 a variable Position is the sum of two mathematical functions [Amount @ Delivery] and Adjustment. The vectors of quantities from two functions should be summarized on the union of two schedules.

DSL parser for compiler or translator can be generated from grammatical descriptions to target language using any available parser generator like JavaCC, ANTLR or others. This parser creates the tree from mathematical expressions. The tree evaluator resolves the variables and constants and their UOM and translates the operators to the functions which implements these operators and executes them by request. Also, the DSL compiler or translator should have an interface for external functions. The external function interface description should be translated into a function call. For instance, the external library for the option Greeks calculation can be registered in the parser through a special description which includes function name and the parameter definitions. After this registration the user should be able to call the calculator from DSL as Greeks=Option(‘Call’, ‘American’, Prices, Volatilities, IR, ExpirySchedule, Strikes);

Preferable repository implementation for the distributed system is the transactional database but the repository can also be implemented on spreadsheets, XML, text files or their combination.

A data repository editor does not require a custom implementation and can be based on existing tools or embedded into spreadsheets. It should have at least the following operations: select, insert, update, and delete for the unit of measure definitions, business object definitions, and business object instances. Referring to FIG. 2 left window A is a repository navigation tree. It allows organizing the business objects using folders.

What is claimed is:

1. A computer-based method of commodity trading automation comprising: a data repository of the user-defined unit of measure definitions, the user-defined business object definitions with ability to create the calculated attributes at said business object definitions and the user-defined business object instances created from said the business object definitions, a data repository editor and domain specific language compiler or translator which comprises the unit of measure resolving using said unit of measure definitions.

2. A computer-based method of commodity trading automation of claim 1 wherein said the unit of measure definition comprising: base unit of measure and a set of user-defined conversion factors to other unit of measures defined through mathematical functions written in a domain specific language.

3. A commodity trading automation method of claim 1 wherein said business object definition comprising: a set of object attributes defined through a type of said attributes or a unit of measures of said attributes, and the calculated attributes are defined through mathematical functions written in a domain specific language.

4. An object attribute definition type of claim 3 comprising: the primitive types which include at least boolean, integer, floating-point number, string and the collection types which comprise a list, a map and their combinations.

5. An object attribute unit of measure of claim 3 comprising a combination of units of measure concatenated by the binary multiplicative operators comprising: division, multiplication and power.

6. A commodity trading automation method of claim 1 wherein said a data repository editor comprising: unit of measure definition editor, business object definition editor, and business object instance editor and providing at least the following operation with said objects: insert, select, update, delete.

7. A commodity trading automation method of claim 1 wherein said domain specific language compiler or translator comprising: unit of measure and variable resolving processor, mathematical expression processor and interface for external functions.

8. Mathematical expression processor of claim 7 providing arithmetic operators for mathematical functions.
